(19) United States
(12) Patent Application Publication
(10) Pub. No.: US 2014/0236808 A1
(43) Pub. Date: Aug. 21, 2014

(54) Social Networking System for Users Having Portable Electronic Devices with GPS Capabilities and Its Associated Method of Operation

(71) Applicant: Ilarion Bilynsky, Hatfield, PA (US)

(72) Inventor: Ilarion Bilynsky, Hatfield, PA (US)

(21) Appl. No.: 13/769,300

(22) Filed: Feb. 16, 2013

(51) Int. Cl. H04L 12/58; G06Q 50/00

(52) U.S. Cl. CPC H04L 51/32; G06Q 50/01
USPC 705/39; 709/204

(57) ABSTRACT

A system and method of operating a social network for individuals who have portable electronic devices that can calculate location using GPS signals. A website is provided. Individuals and commercial entities join the social network through the website. Individuals download operational software to their portable electronic devices. Once loaded and running, the operational software forwards the location of each registered portable electronic device to the network server. The operational software enables each registered user to become an event post initiator by creating an event post. Each event post is accessible by other registered users only within a predetermined radius of the event post initiator. The event posts are displayed on the portable electronic devices of other users. Event posts can be directed to the general public or to a private network of friends.

### BACKGROUND OF THE INVENTION

1. Field of the Invention

In general, the present invention relates to software applications for portable electronic devices that enable those portable electronic devices to calculate their positions and transmit those positions to another. The present invention also relates to the operational methodology of social network systems that are accessible using portable electronic devices.

2. Prior Art Description

In modern society many people have smart phones, tablets, or other portable electronic devices that are capable of communicating with a mobile communications network and/or with a wifi transceiver that provides access to the Internet. Many of these portable electronic devices also contain GPS antennas that enable the portable electronic devices to receive positional information directly from global positioning satellites. The portable electronic devices typically use the positional information for various navigation applications that provide directions when traveling from point to point.

In the prior art, many software applications have been developed for portable electronic devices that enable the portable electronic devices to receive GPS signals, calculate a location, and transmit that location over a communications network to the computer of a specific user. Such software applications are typically used by companies to track the locations of deliveries or workers. Variations of such software applications are also used by parents to track the location of children and other family members. Such prior art software applications are exemplified by U.S. Patent Application Publication No. 2010/0022255 to Singhal, entitled Systems And Methods For Location And Movement Tracking Using GPS Enabled Cell Phones.

In modern society, many people currently belong to social networks on the Internet. Social networks enable people to exchange information with selected friends and acquaintances who are also on that social network. However, unless people on a social network intentionally post their exact location, other selected friends have no way of knowing where any one individual is at any point in time. Friends can be at the same movie or at the same event and have no idea that the other is present.

U.S. Pat. No. 7,593,740 to Crowley, entitled Location Based Social Software For Mobile Devices discloses the software application commonly referred to as Dodgeball®. This software enables user's to text their location to a central service. The central service then notifies them of friends and interesting events nearby. The location of the user is not passive. The system requires the user to actively text their location to the service. As such, the accuracy of the information is only as recent as the last text. If a user does not provide a text, the system has no way of passively determining the location of the users.

The present invention is a social network operating system with application software that can be downloaded to portable electronic devices. The system is passive and enables location information to be automatically generated by portable electronic devices using the GPS satellite system. The system then uses this information to inform a targeted group of friends and/or acquaintances as to the physical location of a person, place, or event that may be of interest to the group. The details of the social network system are described and claimed below.

### SUMMARY OF THE INVENTION

The present invention is a system and method of operating a social network for individuals who have portable electronic devices that can calculate location using GPS signals. A website is provided that is accessible to the general public through the Internet. The website is supported by at least one network server. The network servers hold operational software that is downloadable to the portable electronic devices of users through the website.

Individuals and commercial entities can join the social network through the website. Individuals download the operational software from the network server to their portable electronic devices. Once loaded and running, the operational software forwards the location of each registered portable electronic device to the network server. The operational software enables each registered user to become an event post initiator by creating an event post. Each event post is accessible by other registered users only within a predetermined radius of the event post initiator.

The event posts are displayed on the portable electronic devices of other users. Event posts can be directed to the general public or to a private network of friends. The social network system can track users running the operational software. Accordingly, users can be tracked to see if they attend posted events. System usage fees can then be charged that are dependent either upon the notification radius of a post or the number of users who attend a posted event.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic overview of the infrastructure required by the present invention social network system;

FIG. 2 shows a block diagram schematic that outlines the operational methodology of the social network system;

FIG. 3 shows a simple exemplary notification screen on a portable electronic display;

FIG. 4 shows a block diagram schematic that outlines the methodology for determining a user's notification radius; and

FIG. 5 shows a complex exemplary notification display on a portable electronic display.

### DETAILED DESCRIPTION OF THE DRAWINGS

Although the present invention social network system can be used for many purposes, its operational methodology is best described by using only a few directed examples. The examples selected present some of the best modes contemplated for the invention. The described examples, however, are merely exemplary and should not be considered a limitation when interpreting the scope of the appended claims.

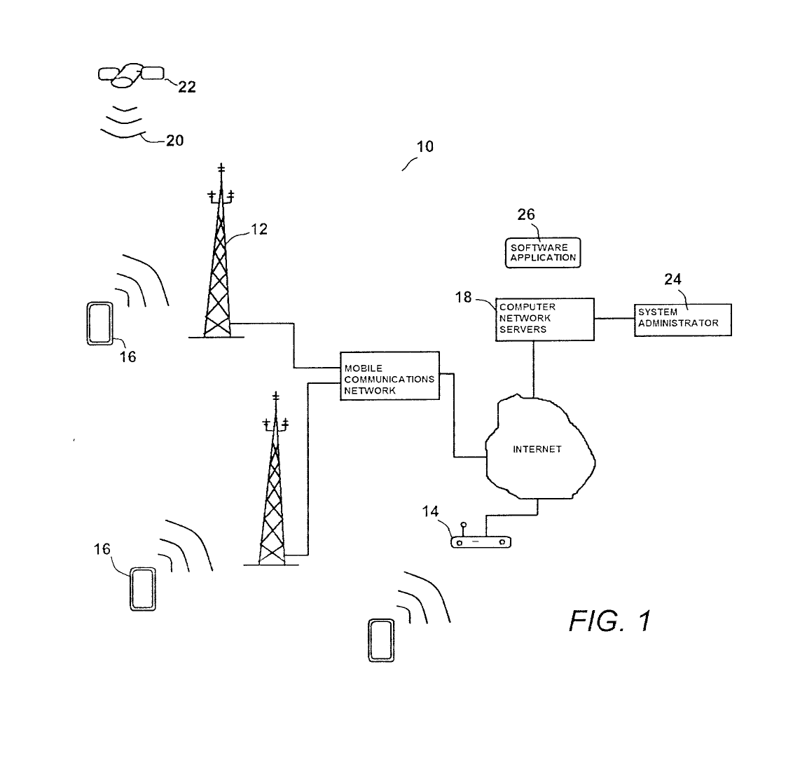

Referring to FIG. 1, the infrastructure required to run the present invention social network system 10 is explained. In a large geographic area, there are numerous cell phone towers 12 and wifi transceivers 14. Also in a large geographic area there are many individuals who have portable electronic devices 16. The portable electronic devices 16 communicate by sending and receiving signals via the cell phone towers 12 and wifi transceivers 14. This enables the portable electronic devices 16 to communicate with computer network servers 18 that can be located anywhere on the globe.

The large geographic area also receives signals 20 from the orbiting satellites 22 of the global positioning system. These GPS signals 20 are received by the portable electronic devices 16, provided the portable electronic devices 16 are equipped with GPS antennas. Commercial electronics and software contained within portable electronic devices 16, enable the portable electronic devices 16 to calculate their exact positions within the large geographic area using the GPS signals 20 being received. Utilizing the infrastructure shown in FIG. 1, it will be understood that provided the proper software applications are being run by the portable electronic devices 16, each portable electronic device 16 is capable of transmitting its exact physical location to one of the computer network servers 18 operated by the system administrator 24 for the present invention social network system 10.

Once the software application 26 of the present invention social network system 10 is downloaded to a registered user's portable electronic device 16, the software application 26 causes the portable electronic device 16 to calculate its physical location using GPS signals 20 and periodically ping that location to the computer network servers 18. That is, if a user is running the software application 26 for the social network system 10, the user's portable electronic device 16 will periodically transmit its location to the computer network servers 18 so that the system administrator 24 can be aware of the location of the user.

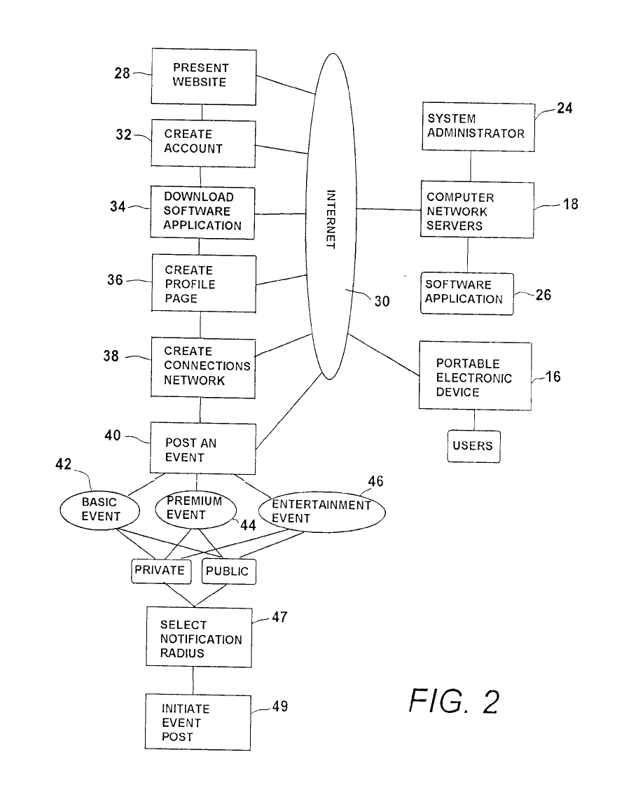

Referring to FIG. 2 in conjunction with FIG. 1, the details of the operational methodology of the present invention social network system 10 are explained. The system administrator 24 presents a social network website on the Internet by running website software in the computer network servers 18. See Block 28. The website hosting the social network system 10 can be accessed by any member of the public via the Internet 30. Members of the general public can join the social network system 10 by creating an account. As is indicated by Block 32, users create an account with the system administrator 24. The system administrator 24 provides the users with account and password identification codes that enable each registered user to access the system 10.

Once a user is properly registered, the user can download the software application 26 to his/her portable electronic devices 16 that is needed for the social network system 10 to run. See Block 34. Once a user is registered and has downloaded the software application 26 to his/her portable electronic device 16, the user can create a profile page in the social network system 10 that is accessible through the website. See Block 36. Each user can then invite and accept other users as linked friends, herein called a user's connections network. See Block 38.

Once a user is established with a profile page and a connections network, a user can post an event. See Block 40. Events come in different types, and include basic events 42, premium events 44, and entertainment events 46. Each event type will be explained separately.

For a “basic” event 42, a user initiates an event by posting an event on his/her profile page. The basic event 42 can be either public or private. If the basic event 42 is public, everyone in a certain notification radius is informed of the basic event 42. For example, a public basic event might be a posting for a garage sale. Such a public basic event would then be posted to all registered members of the social network system 10 within a predetermined notification radius.

If the basic event 42 is private, the basic event is posted only to the user's connections network. For example, a user may be in a bar and the user may post a private basic event 42, stating “come meet me at the bar”. This private basic event 42 post will then be transmitted to all the people in the user's connections network that are within a predetermined radius of the user. The user can select the notification radius. For example, the notification radius can be one mile, five miles or ten miles. The private basic event 42 is then sent to all the people in the user's connections network who are currently within that radius. See Blocks 47 and 49. Details of determining a user's notification radius are later explained.

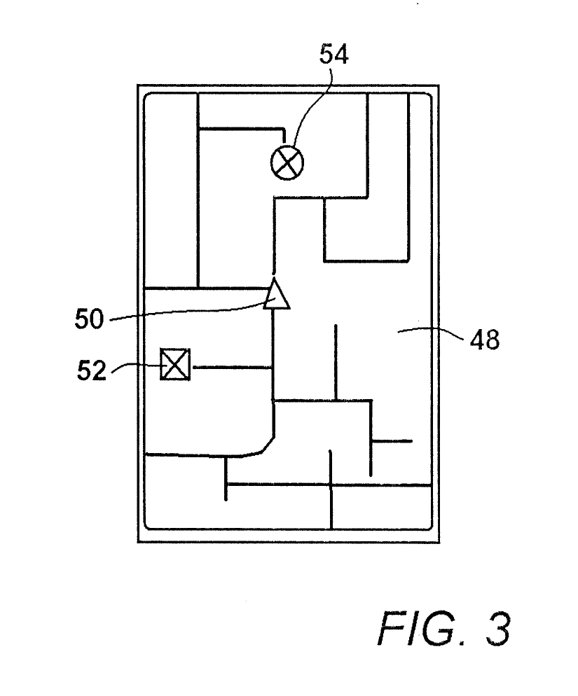

Referring to FIG. 3, an exemplary notification screen 48 on the portable electronic device 16 of one of a person in the user's connections network is shown. The center icon 50 of the notification screen 48 indicates the current location of the person who has received the event notice. The notification screen 48 may also show a location icon 52 for the user who initiated the event notice, provided the event notice was a private basic event 42. The notification screen 48 can also show a location icon for the event (i.e. meeting at the bar) and the time of the event. In many situations, the location of the user who posted the event and the location of the event may be the same. However, this need not be the case. For example, a user may post a basic event as, “birthday party tomorrow at pizzeria”. In such a scenario, the user is not at the event location at the time of the post.

The transmission of the location of the user is useful in many situations. For example, a user may post a private basic event 42 to his/her connections network stating “meet me at the movies”. A person in the user's connections network can then see that he/she is much closer to the movies than the icon 52 of the initiator who made the post. That person may then decide that they have time to run an errand or get changed before proceeding to the movies.

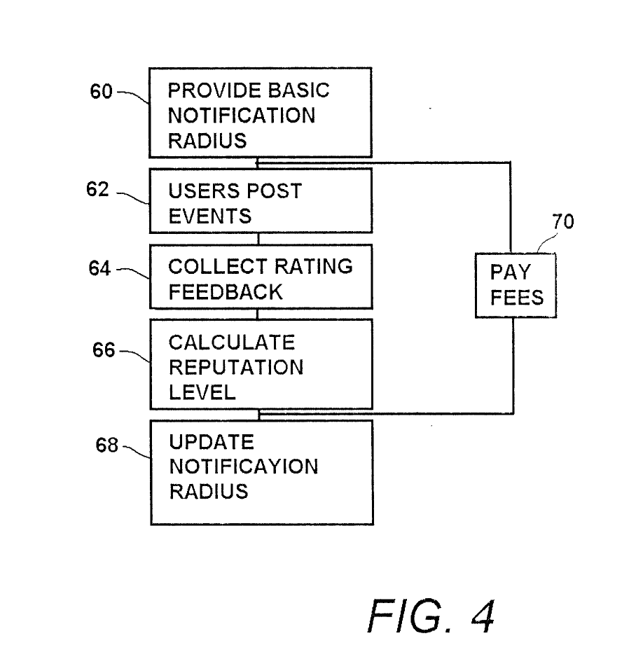

As is indicated by Block 47 in FIG. 2, a specific user can select a notification radius. However, limitations do exist on the size of the notification radius. Referring now to FIG. 4 in conjunction with FIG. 2, it will be understood that the length of the notification radius is dynamic and depends upon the account reputation of the user. Initially each new user is provided with a basic notification radius. See Block 60. The user can initiate event posts to users within that notification radius. See Block 62. Each user will have a reputation level tied to his/her profile. The reputation level is very important in public event posts, where the people who receive the posts do not have a personal relationship with the user making the post. The reputation level helps users determine whether or not to visit the events posted by a particular user. Once a person has visited a posted event for a specific period of time, that person will be able to rate their experience using a simple scale rating system, such as a scale of one-to-ten. The ratings are transmitted back to the system administrator 24. See Block 64. Using software, the system administrator 24 calculates a reputation level for each user. See Block 66. That reputation level is updated from every event post. See Block 68. If a user consistently gets high ratings, then that person's notification radius can be increased. Furthermore, posts by users with different reputation ratings can be displayed with different icons on the notification screen of others. In this way other people can immediately tell if an event notice is an event that should be attended or not. This reputation ranking prevents people from falsely promoting events or posting events that are self-serving and not interesting to the general public.

Although the social network system 10 involves users that are part of a social network, commercial entities can also register as users. The second type of event that can be posted is a premium event 44. A premium event 44 can only be posted by a registered commercial entity. The system administrator 24 may perform a background check to verify the legitimacy of any commercial entity registration. Commercial entities can post premium events 44 for a fee. The system administrator 24 can charge different fees for different notification radii. See Block 70. This is a primary income source to the system administrator 24. A posting for a premium event 44 is typically a public posting. However, a commercial user can make the posting private for selective clientele. Furthermore, a commercial user can post coupons, discounts, promotion codes rebates and the like to entice customers. For example, a car dealership may post a public premium event of a sale to the area in a twenty mile radius. The same car dealership may post a private premium event to previous customers offering an additional rebate.

A third type of event that can be posted is an entertainment event 46. Entertainment events 46 may be posted directly by the system administrator 24 or by qualified event promoters who have registered with the system administrator 24. The entertainment event 46 can be real or virtual. An example of a real entertainment event may be a concert on a national tour. A concert promoter who has a concert traveling to Philadelphia can post an entertainment event post promoting that concert within the greater Philadelphia area. Promoters can offer discounts or upgrades through the post.

An example of a virtual entertainment event may be a game that is posted by the systems administrator 24. The game post encourages users in a certain geographical area to play a particular game on-line. Users who play the game can earn virtual credits that can be redeemed for coupons, merchandise, or other promotional items.

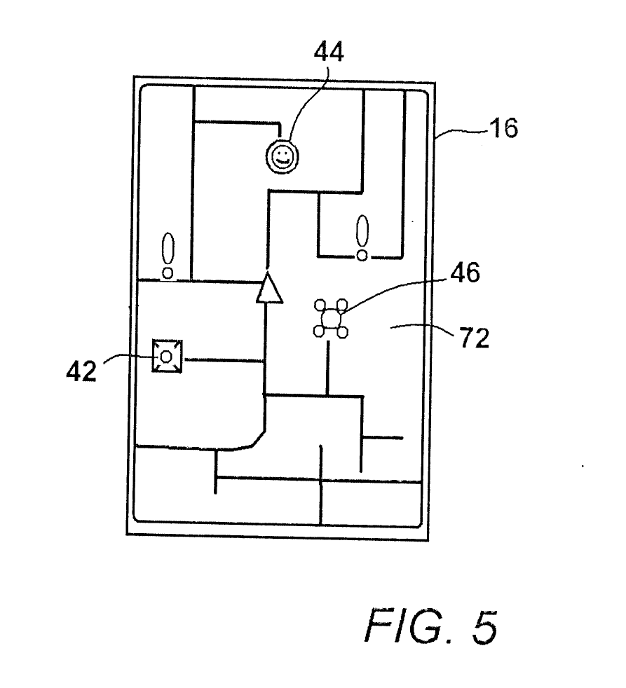

Referring to FIG. 5, a full notification screen 72 is illustrated that has basic posts 42, premium posts 44, and entertainment posts 46 being displayed. Referring to the notification screen 72 of FIG. 5 and the mythology of FIG. 2, it will now be understood that when a user runs the software application on his/her portable electronic device 16, the notification screen 72 will have private posts from friends, public posts from friends, posts from commercial entities and posts from entertainment events. Each of these posts will appear as icons on the notification screen 72. The icons will vary in color, shape, and/or size to inform the user as to the source, reputation rating and importance of the post.

In an urban setting, a person with a large connections network can be presented with numerous posts even within a small geographic area. Each user will have the ability to filter the post results being displayed. For example, a user can filter the results to show posts only from certain people, or only from certain businesses. Each user can also filter results for a specific geographic area, a specific date and/or a specific time frame. The systems administrator 24 can also charge commercial entities and entertainment promoters a premium for special icons that will help their posts stand out in a crowded area.

The systems administrator 24 makes money by charging commercial entities and entertainment promoters for posts. However, to entice commercial entities and promoters to use the social network system 10, the system administrator 24 can charge these users depending upon how many people respond to a post. The social network system 10 enables the system administrator 24 to track the physical locations of users who are running the software application on their portable electronic devices 16. As such, the systems administrator 24 can track how many of the system's users actually attend a posted event. For example, suppose a restaurant posts a two-for-one special. The systems administrator 24 can track how many users go to that restaurant during the time of that special. The restaurant can then be charged a fee for each user that attends. In this manner, a commercial entity can be charged only a minimum fee to make a post. The commercial entity will then be charged more according to how many system users respond to that post by traveling to a certain location. Commercial users and entertainment promoters will be far more likely to pay for posts on the social network system 10, provided they only have to pay for clients generated by the use of the social network system.

It will be understood that the methodology and examples of the present invention social network system that are illustrated and described are merely exemplary and that a person skilled in the art can make many variations to those embodiments. For instance, users such as public entities and non-profit entities can be given accounts to make special posts. Posts can therefore be made regarding child abductions, emergency warnings, and the like. All such embodiments are intended to be included within the scope of the present invention as defined by the claims.

What is claimed is:

1. A method of operating a social network for users who operate portable electronic devices that can calculate location from GPS signals, said method comprising the steps of:
loading operational software into said portable electronic devices that enable said portable electronic devices to periodically transmit said location to at least one computer network server when said operational software is running, wherein said operational software enables each of said users to transmit an event post and become an event post initiator;
displaying said event post, via said electronic portable devices, only to other of said users within a predetermined geographic area surrounding said event post initiator.

2. The method according to claim 1, wherein said method further includes the step of having each of said users invite other of said users to join a private connection network.

3. The method according to claim 2, wherein said step of displaying said event post, via said electronic portable devices, only to other of said users within a predetermined geographic area surrounding said event post initiator, includes displaying said event post only to other of said users in said private connection network of said event post initiator.

4. The method according to claim 1, further including the step of registering commercial users, wherein said commercial users can generate commercial posts to said users within a specified geographic area.

5. The method according to claim 4, further including the step of charging a fee to said commercial users for each of said commercial posts generated.

6. The method according to claim 4, further including the step of tracking said location of each of said users who respond to said commercial posts of said commercial users.

7. The method according to claim 6, further including the step of charging said commercial users a fee proportional to said users who respond to said commercial posts.

8. The method according to claim 1, wherein said event post identifies an event location and a timeframe and wherein said method further includes the step of tracking said location of each of said users to determine which of said users go to said event location within said timeframe.

9. The method according to claim 8, further including the step of having said users who go to said event location in said timeframe rank said event post initiator.

10. The method according to claim 8, further including the step of varying said specified geographic area as a function of said rank.

11. A method of operating a social network for individuals who have portable electronic devices that can calculate location using GPS signals, said method comprising the steps of:
providing a website accessible to said individuals, wherein said website is supported by at least one network server, and wherein said at least one network server has operational software downloadable to said portable electronic devices through said website;
registering at least some of said individuals through said website, therein providing individual registered users;
downloading said operational software from said network server to said portable electronic devices of said individual registered users, wherein said operational software forwards said location to said at least one network server when said operational software is running;
and wherein said operational software enables each of said individual users to create event posts and become an event post initiator, wherein said event posts are accessible by other of said individual registered users only within a predetermined radius of said event post initiator.

12. The method according to claim 11, wherein said method further includes the step of having each of said individual registered users invite other of said individual registered users to join a private connection network.

13. The method according to claim 12, wherein said event posts are only accessible by said individual registered users in said private connection network of said event post initiator.

14. The method according to claim 11, further including the step of registering commercial users, wherein said commercial users can generate commercial posts to said registered individual users within a specified geographic area.

15. The method according to claim 14, further including the step of charging a fee to said commercial users for each of said commercial posts generated.

16. The method according to claim 14, further including the step of tracking said location of each of said registered individual users who respond to said commercial posts of said commercial users.

17. The method according to claim 16, further including the step of charging said commercial users a fee proportional to said registered individual users who respond to said commercial posts.

18. The method according to claim 14, wherein said commercial posts identify an event location and a timeframe, and wherein said method further includes the step of tracking said location of each of said registered individual users to determine which of said registered individual users go to said event location within said timeframe.

19. A method of operating a social network for users who operate portable electronic devices that can calculate location from GPS signals, said method comprising the steps of:
downloading operational software to said portable electronic devices of said users, wherein said operational software forwards said location to at least one network server when said operational software is running;
enabling said users to post event posts that are accessible by others of said users through said portable electronic devices, wherein said event posts contain an event location and an event timeframe;
tracking which of said users respond to said event posts by going to said event location within said event timeframe.

20. The method according to claim 19, further including the step of charging a user who posts an event post a fee proportional to the number of other said users that respond to said event post.
